(19) United States
(12) Patent Application Publication
(10) Pub. No.: US 2005/0135610 A1
(43) Pub. Date: Jun. 23, 2005

(54) Identifier-based signcryption

(76) Inventors: Liqun Chen, Bristol (GB); John Malone-Lee, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/977,342

(22) Filed: Oct. 29, 2004

(30) Foreign Application Priority Data
Nov. 1, 2003 (GB) 0325527.0
Jul. 15, 2004 (GB) 0415779.8

(51) Int. Cl. H04L 9/30

(52) U.S. Cl. 380/30; 713/170

(57) ABSTRACT

Identifier-based signcryption methods and apparatus are disclosed both for signing and encrypting data, and for decrypting and verifying data. The signcryption methods use computable bilinear mappings and may be based, for example, on Weil or Tate pairings. Known, efficient, signing/verifying processes are judiciously combined with particular encryption/decryption processes to achieve efficient, yet secure, signcryption methods.

### FIELD OF THE INVENTION

The present invention relates to methods and apparatus for implementing an identifier-based signcryption cryptographic scheme. A “signcryption” scheme is one that combines both data encryption and signature to obtain private and authenticated communications.

### BACKGROUND OF THE INVENTION

As is well known to persons skilled in the art, in “identifier-based” cryptographic methods a public, cryptographically unconstrained, string is used in conjunction with a public key of a trusted authority to carry out tasks such as data encryption and signing. The complementary tasks, such as decryption and signature verification, require the involvement of the trusted authority to carry out a computation based on the public string and a private key that is related to its public data. In message-signing applications and frequently also in message encryption applications, the string serves to “identify” a party (the sender in signing applications, the intended recipient in encryption applications); this has given rise to the use of the label “identifier-based” or “identity-based” generally for these cryptographic methods. However, at least in certain encryption applications, the string may serve a different purpose to that of identifying the intended recipient and, indeed, may be an arbitrary string having no other purpose than to form the basis of the cryptographic processes. Accordingly, the use of the term “identity-based” or “identifier-based” herein in relation to cryptographic methods and systems is to be understood simply as implying that the methods and systems are based on the use of a cryptographically unconstrained string whether or not the string serves to identify the intended recipient. Furthermore, as used herein the term “string” is simply intended to imply an ordered series of bits whether derived from a character string, a serialized image bit map, a digitized sound signal, or any other data source.

The current most practical approach to building identifier-based cryptosystems uses bilinear pairings. A brief overview of pairings-based cryptography will next be given. In the present specification, G1 and G₂ denote two algebraic groups of large prime order l in which the discrete logarithm problem is believed to be hard and for which there exists a non-degenerate computable bilinear map p, for example, a Tate pairing or Weil pairing. Note that G₁ is a [l]-torsion subgroup of a larger algebraic group G₀ and satisfies [l]P=O for all P ε G₁ where O is the identity element, l is a large prime, and l*cofactor=number of elements in G₀. The group G₂ is a subgroup of a multiplicative group of a finite field.

For the Weil pairing:, the bilinear map p is expressed as
p: G₁×G₁ →G₂.

The Tate pairing can be similarly expressed though it is possible for it to be of asymmetric form:
p: G₁×G₀→G₂

Generally, the elements of the groups Go and GI are points on an elliptic curve (typically, though not necessarily, a supersingular elliptic curve); however, this is not necessarily the case.

For convenience, the examples given below assume the use of a symmetric bilinear map (p: G₁×G₁→G₂) with the elements of GI being points on an elliptic curve; however, these particularities, are not to be taken as limitations on the scope of the present invention.

As is well known to persons skilled in the art, for cryptographic purposes, modified forms of the Weil and Tate pairings are used that ensure p(P,P)≠1 where P ε G₁; however, for convenience, the pairings are referred to below simply by their usual names without labeling them as modified.

As the mapping between G₁ and G₂ is bilinear, exponents/multipliers can be moved around.

For example if a, b, c ε Z (where Z is the set of all integers) and P, Q ε G₁ then

$$\begin{matrix}{p ( aP , bQ )}^{c} = {p ( aP , cQ )}^{b} = {p ( bP , cQ )}^{a} = {p ( bP , aQ )}^{c} = {p ( cP , aQ )}^{b} = \\ {p ( cP , bQ )}^{a} \\ = {p ( abP , Q )}^{c} = p ( abP , cQ ) = {p ( P , abQ )}^{c} = p ( cP , abQ ) \\ = … \\ = p ( abcP , Q ) = p ( P , abcQ ) = {p ( P , Q )}^{abc}\end{matrix}$$

A normal public/private key pair can be defined for a trusted authority:
the private key is s
   where s ε Zₗ and
the public key is (P, R)
   where P and R are respectively master and derived public elements with P ε G₁ and R ε G₁, P and R being related by R=sP

With the cooperation of the trusted authority, an identifier-based public key/private key pair <Q_{ID}, S_{ID}> can be defined for a party with identity string ID where:
Q_{ID}, S_{ID} ε G₁.
S_{ID}=sQ_{ID}
Q_{ID}=H₁(ID)
H₁ is a hash: {0,1}*→G₁

Further background regarding Weil and Tate pairings and their cryptographic uses (such as for encryption and signing) can be found in the following references:
G. Frey, M. Müller, and H. Rück. The Tate pairing and the discrete logarithm applied to elliptic curve cryptosystems. IEEE Transactions on Information Theory, 45(5):1717-1719, 1999.
D. Boneh and M. Franklin. Identity based encryption from the Weil pairing. In Advances in Cryptology—CRYPTO 2001, LNCS 2139, pp.213-229, Springer-Verlag, 2001.

With regard to the latter reference, it may be noted that this reference describes both a fully secure encryption scheme using the Weil pairing and, as an aid to understanding this fully-secure scheme, a simpler scheme referred to as “BasicIdent” which is acknowledged not to be secure against a chosen ciphertext attack.

As already mentioned above, the present invention is concerned with signcryption cryptographic schemes. A “signcryption” primitive was proposed by Zheng in 1997 in the paper: “Digital Signcryption or How to Achieve Cost(Signature & Encryption)<<Cost(Signature)+Cost(Encryption).” Y. Zheng, in Advances in Cryptology—CRYPTO '97, volume 1294 of Lecture Notes in Computer Science, pages 165-179, Springer-Verlag, 1997. This paper also proposed a discrete logarithm based scheme.

Identity-based signcryption is signcryption that uses identity-based cryptographic algorithms. A number of identity-based signcryption schemes have been proposed such as described in the paper “Multipurpose Identity-Based Signcryption: A Swiss Army Knife for Identity-Based Cryptography” X. Boyen, in Advances in Cryptology—CRYPTO 2003, volume 2729 of Lecture Notes in Computer Science, pages 382-398, Springer-Verlag, 2003. This paper also proposes a security model for identity-based signcryption that is based on six algorithms SETUP, EXTRACT, ENCRYPT, DECRYPT and VERIFY. For convenience of describing the prior art and the preferred embodiments of the invention, a similar set of six algorithms is used herein and the functions of each of these algorithms will now be described with reference to FIG. 1 of the accompanying drawings; it should, however, be understood that the present invention is not intended to be limited to implementations using such a set of six algorithms.

In FIG. 1 the algorithms SETUP 20 and EXTRACT 21 are associated with a trusted authority, the algorithms SIGN 22 and ENCRYPT 23 with a party A, and the algorithms DECRYPT 24 and VERIFY 25 with a party B. The functions of these algorithms are as follows:
SETUP—On input of a security parameter k this algorithm produces a pair <params, s> where “params” are the global public parameters for the system and s is the master secret key. The public parameters “params” include a global public key R, a description of a finite message space M, a description of a finite signature space S, and a description of a finite ciphertext space C. It is assumed below that “params” are publicly known and are therefore not explicitly provided as input to the other algorithms.
EXTRACT—On input of an identity ID_{U} and the master secret key s, this algorithm computes a secret key Su corresponding to ID_{U}.
SIGN—On input of <m, SA>, this algorithm produces a signature σ on m under ID_{A} and some ephemeral state data r.
ENCRYPT—On input of <S_{A}, ID_{B}, m, σ, r>, this algorithm produces a ciphertext c. This is the encryption under ID_{B}'s public key of m and of ID_{A}'s signature on m.
DECRYPT—on input of <c′, S_{B}>, this algorithm produces (m′, ID_{A}′, σ′) where m′ is a message and σ is a purported signature on m′ of party with identity ID_{A}′.
VERIFY—On input of <m′, ID_{A}′, σ′>, this algorithm outputs True if σ′ is the signature of the party represented by ID_{A} on m, and it outputs False otherwise.

The marking of a quantity with ′ (as in m′) is to indicate that its equivalence to the unmarked quantity has to be tested.

The above individual algorithms 20 to 25 have the following consistency requirement. If:
(m, σ, r)←SIGN(m, S_{A})
   c←ENCRYPT(S_{A}, ID_{B}, m, σ, r)
(m′, ID_{A}′, σ′)←DECRYPT(c, S_{B})

Then the following must hold:
ID_{A}′=ID_{A}
   m′=m
True←VERIFY(m′, ID_{A}′, σ′)

It should be noted that other ways of modelling identity-based signcryption exist; for example, the signing and encryption algorithms may be treated as a single signcryption algorithm as are the decryption and verification algorithms. However, the above-described model will be used in the present specification.

The implementation of a signcryption scheme using the above six algorithms is straight-forward:
a trusted authority first executes SETUP;
the trusted authority executes EXTRACT to provide party A with the latter's secret key S_{A};
party A executes SIGN to form a signature σ on a message m, and ENCRYPT to encrypt the message m together with the signature;
the trusted authority executes EXTRACT to provide party B with the latter's secret key S_{B};
party B executes DECRYPT to recover m′, σ′ and a sender identity, and then VERIFY to verify the signature.

It will be appreciated that the execution of EXTRACT to provide S_{B} can be carried out at any time before DECRYPT is run.

The specific identity-based signcryption scheme described in the above-referenced paper by Boyen is based on bilinear pairings with the algorithms being implemented as follows:

SETUP

Establish public parameters G₁, G₂, l, q and the following cryptographic hash functions:
H₁: {_{0,1}}^{k}^{₁}→G₁
H₂: {0,1}^{k}^{₀}⁺ⁿ →Zₗ*
H₃: G₂→{0,1}^{k}^{₀}
H₄: G₂→Zₗ*
H₅: G₁→{0,1}^{k}^{₁}⁺ⁿ
   where: k₀ is the number of bits required to represent an element of G₁;
k₁ is the number of bits required to represent an identity; and
n is the number of bits of a message to be signed and encrypted.

Choose P such that <P>=G₁ that is, P is a generator for the cyclic group G₁.

Choose s uniformly at random from Zₗ*.

Compute the global public key R←sP.

EXTRACT

To extract the private key for user U with ID_{U} ε {0,1}^{k}^{ₐ}:
compute the public key Q_{U}←H₁(ID_{U})
compute the secret key S_{U}←sQ_{U}
   SIGN

For user A with identity ID_{A} to sign a message m ε {0,1}″ with private key S_{A} corresponding to public key Q_{A}←H₁(ID_{A}):
choose r uniformly at random from Zₗ* and compute:
   X←rQ_{A}
compute:
   h←H₂(X∥m)
      where ∥ indicates concatenation
   J←(r+h)S_{A}
return r and the signature σ=<X, J>.
   ENCRYPT

For user A with identity IDA to encrypt message m, using r and a output by SIGN, for user B with identity ID_{B}:
compute:
   Q_{B}←H₁(ID_{B})
   w←P (S_{A}, Q_{B})
   t←H₄(w)
   Y←tX
   u←w^{tr}
compute:
   f=H₃(u)⊕J
   v=H₅(J)⊕(ID_{A}∥m)
return the ciphertext c: <Y,f, v>.
   DECRYPT

For user B with identity ID_{B} to decrypt ciphertext c′: <Y′,f′, v′> using S_{B}←sH₁(ID_{B}):
compute:
   u′←p (Y′, S_{B})
   J′←f′⊕H₃(u′)
compute:
   H₅(J′)⊕v′
to recover string: ID_{A}′∥m′
compute:
   Q_{A}′←H₁(ID_{A}′)
   w′←P(Q_{A}′, S_{B})
   t′←H₄(w′)
   X′←(t′)⁻¹ Y
return the message m′, the signature σ′=<X′, J′>, and the identity ID_{A}′ of the purported sender.
   VERIFY

To verify that the signature σ′ on message m′ is that of user A where A has identity ID_{A}:
compute:
   h′←H₂(X′∥m′)
check whether:
p(P, J′)=p(R, X′+h′Q_{A}′)
and, if so, return True, else return False.

The foregoing signature algorithm SIGN is based on an efficient signature scheme proposed in the paper “An Identity-Based Signature from Gap Diffie-Hellman Groups” J. C. Cha and J. H. Cheon, in Public Key Cryptography—PKC 2003, volume 2567 of Lecture Notes in Computer Science, pages 18-30, Springer-Verlag, 2003.

It is an object of the present invention to provide an identity-based signcryption scheme with improved efficiency.

### SUMMARY OF THE INVENTION

According to one aspect of the present invention, there is provided an identifier-based signcryption method in which a first party associated with a first element Q_{A} signcrypts subject data m intended for a second party associated with a second element Q_{B}, the first and second elements being formed from identifier strings ID_{A} ID_{B} of the first and second parties respectively such that the first and second elements are both members of an algebraic group G₀ with at least one of these elements being in a subgroup G₁ of G₀ where G₁ is of prime order l and in respect of which there exists a computable bilinear map p; the method comprising the first party:
(a) signing m by computing:
   X←rQ_{A}
      where r is randomly chosen in Zₗ*;
   h←H₂(C₁(at least X and m))
      where H₂: {0,1 }*→Zₗ and C₁( ) is a deterministic combination function,
   J←(r+h)S_{A}
      where S_{A}=sQ_{A} is a private key supplied by a trusted authority and s is a secret key held by the trusted authority;
(b) encrypting m and signature data by computing:
   w as the bilinear mapping of elements rS_{A} and Q_{B}, and
   f←Enc(w, C₂(at least J and m))
      where Enc( ) is a symmetric-key encryption function using w as key, and C₂( ) is a reversible combination function;
(c) outputting ciphertext comprising X and f

The signature step is based on the same signature algorithm as used by the Boyen prior art signcryption scheme described above; however, the encryption step uses a more efficient algorithm to that of Boyen. In fact, analysis shows that the encryption step uses an algorithm similar to the “BasicIdent” encryption algorithm described in the above-mentioned paper by Boneh and Franklin. However, the way the encryption step is carried out with respect to the signature step now ensures that the signcryption method of the invention is secure against a chosen ciphertext attack unlike the “BasicIdent” algorithm itself.

According to another aspect of the present invention, there is provided an identifier-based signcryption method in which a second party associated with a second element Q_{B} decrypts and verifies received ciphertext <X′,f′> that is purportedly a signcryption of subject data m by a first party associated with a first element Q_{A}, the first and second elements being formed from identifier strings ID_{A}, ID_{B} of the first and second parties respectively such that the first and second elements are both members of an algebraic group G₀ with at least one of these elements being in a subgroup G₁ of G₀ where G₁ is of prime order l and in respect of which there exists a computable bilinear map p; the method comprising the second party:
(a) decrypting the received ciphertext by computing:
   w′ as a bilinear mapping of elements X′ and S_{B}
      where S_{B}=sQ_{B} is a private key supplied by a trusted authority, s is a secret key held by the trusted authority;
   Dec(w′,f′)
      where Dec( ) is a symmetric-key decryption function using w′ as key, with at least quantities J′ and m′ being recovered from the result;
(b)verifying that the message is from the first party by computing:
   Q_{A}′←H₁(ID_{A}′)
      where H₁( ) is a hash function;
   h′←H₂(C₁(at least: X′ and m′))
      where H₂: {0,1}*→Zₗ and C₁( ) is a deterministic combination function,
and then checking whether:
   p(P, J′)=p(R,X′+h′Q_{A}′)
      where P is an element of G₁ and R=sP is a public key element formed by the trusted authority.

It will be appreciated by persons skilled in the art that the check carried by the second party and expressed above as:
p(P, J′)=p(R, X′+h′Q_{A}′)
   can be expressed in a variety of different forms due to the bilinear nature of the mapping p with each form of expression having a corresponding computational implementation. All implementations of the equivalent expressions effectively perform the same check and accordingly the foregoing statement of the invention is not to be read as restricted by the form of expression used to specify the check.

The present invention also encompasses apparatus, systems and computer program products embodying the methods of the invention.

### BRIEF DESCRIPTION OF THE DRAWINGS

Embodiments of the invention will now be described, by way of non-limiting example, with reference to the accompanying diagrammatic drawings, in which:

FIG. 1 is a diagram illustrating component algorithms of an identity-based signcryption scheme according to a prior-art proposal; and

FIG. 2 is a diagram of a system embodying the present invention.

### BEST MODE OF CARRYING OUT THE INVENTION

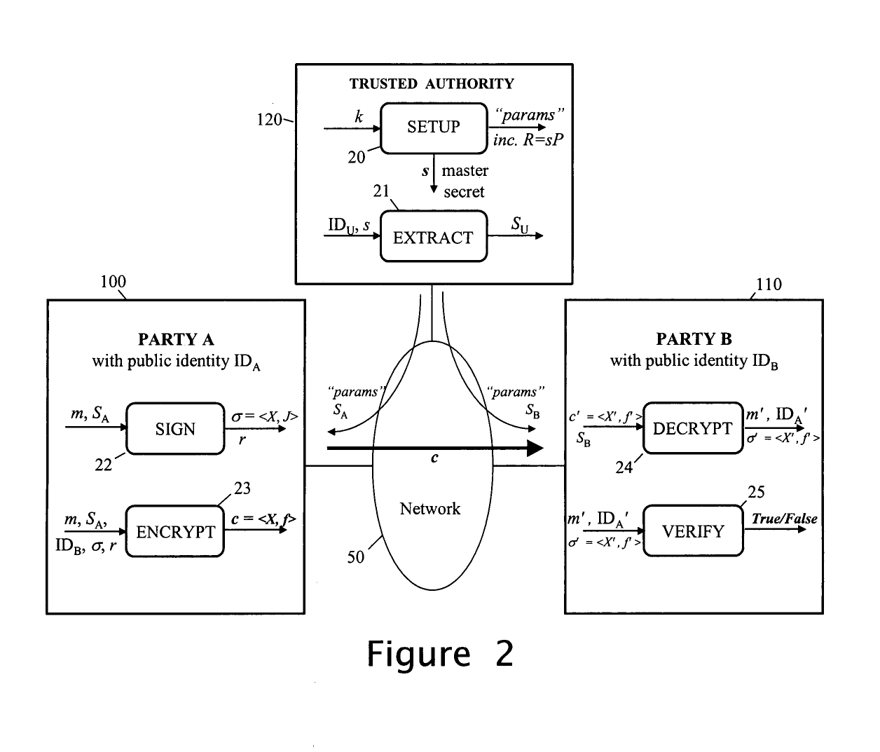

FIG. 2 illustrates a system in which a first computing entity 100 associated with a party A is arranged to sign and encrypt a message m and send it to a second computing entity 110 associated with party B for decryption and verification of the signature. The system employs a signcryption scheme with the entity 100 using a secret S_{A} based on the identity of party A and entity 110 using a secret S_{B} based on the identity of party B; these secrets S_{A}, S_{B} are securely provided by a trusted-authority computing entity 120 to the entities 100, 110 respectively. The entities 100, 110 and 120 inter-communicate, for example, via the internet or other communications infrastructure 51, by direct point-to-point communication, or by data transfer effected using a portable storage medium; it is also possible that two or more of the entities reside on the same computing platform.

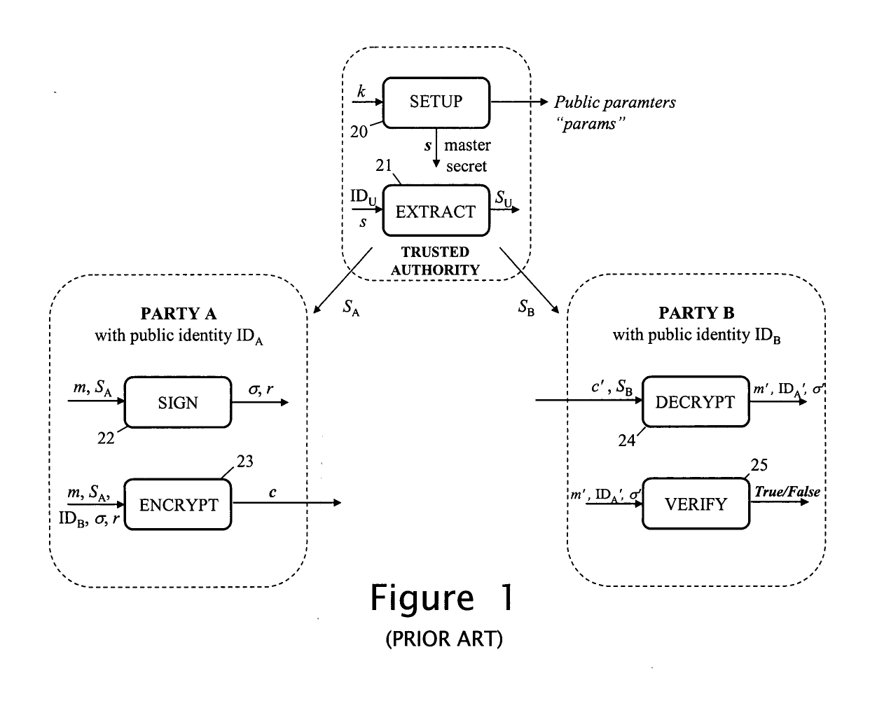

The signcryption scheme implemented by the FIG. 2 system will be described below in terms of the six algorithms SETUP, EXTRACT, SIGN, ENCRYPT, DECRYPT, and VERIFY described above and depicted in FIG. 1, it being appreciated that other models for describing the FIG. 2 signcryption scheme are also possible.

SETUP

Establish public parameters G₁, G₂, q, l and the following cryptographic hash functions:
H₁: {0,1}^{k}^{₁}→G₁,
H₂: {0,1}^{k}^{₀}⁺ⁿ→Z*ₗ
H₃: G₂→{0,1}^{k}^{₁}^{+k}^{₁}⁺ⁿ⁺
where: k₀ is the number of bits required to represent an element of G₁;
k₁ is the number of bits required to represent an identity; and
n is the number of bits of a message to be signed and encrypted.

Choose P such that <P>=G₁ that is, P is a generator for the cyclic group G₁.

Choose s uniformly at random from Zₗ*.

Compute the global public key R←sP.

EXTRACT

To extract the private key for user U with ID_{U} ε {0,1}^{k}^{₁}:
compute the public key Q_{U}←H₁(ID_{U})
compute the secret key S_{U←sQ}_{U}

Thus, user A has a public key Q_{A}←H₁(ID_{A}) and private key S_{A}←sQ_{A}, and user B has a public key Q_{B}←H₁(ID_{B}) and private key S_{B}←sQ_{B}.

SIGN

For user A with identity ID_{A} to sign a message m ε {0,1}″ with private key S_{A} corresponding to public key Q_{A}←H₁(ID_{A}):
choose r uniformly at random from Zₗ* and compute:
   X←rQ_{A}
compute:
   h←H₂(X∥m)
   J←(r+h)S_{A}
return r and the signature σ=,<X, J>.
   ENCRYPT

For user A with identity IDA to encrypt message m, using r and σ output by SIGN, for user B with identity ID_{B}:
compute:
   Q_{B}←H₁(ID_{B})
   w←p(rS_{A}, Q_{B})
compute:
   f←H₃(w)⊕(J∥ID_{A}∥m)
return the ciphertext c: <X,f>.
   DECRYPT

For user B with identity ID_{B} to decrypt ciphertext c′: <X′,f′> using S_{B}:
compute:
   w′←p(X′, S_{B})
compute:
   f⊕H₃(w′)
   which is taken to be the string: J′∥ID_{A}′∥m′ from which the individual components are then be recovered;
return the message m′, the signature σ′=<X′, J′> and the identity ID_{A}′ of the purported sender.
   VERIFY

To verify user A's signature c on message m′ where A has identity ID_{A}′:
compute:
   Q_{A}′←H₁(ID_{A}′)
   h′←H₂(X′∥m′)
check whether:
   p(P,J′)=p(R, X′+h′Q_{A}′)
and, if so, return True, else return False.

As regards application of the above algorithms to the system shown in FIG. 2, it will be appreciated that SETUP and EXTRACT are run by the trusted authority entity 120, SIGN and ENCRYPT by the entity 100 associated with party A, and DECRYPT and VERIFY by the entity 120 associated with party B. As already noted above, the EXTRACT algorithm is, of course, run twice to provide the secrets S_{A} and S_{B} for the parties A and B respectively, this typically only being done for each party A, B after the trusted authority has checked the entitlement of that party to the related identity ID_{A}, ID_{B} (it is noted that in many applications S_{B} will only be generated after party B has received the signcrypted message—in other words, it is not required that all steps of EXTRACT be carried out together before another of the algorithms is commenced).

It will be appreciated that the functionality of the described algorithms will generally be implemented as program code running on the relevant computing entity, this latter typically being built around a general purpose program-controlled processor, however, it is also possible to provide dedicated hardware for executing at least some of the cryptographic processes involved.

Table 1 below gives comparative figures for the efficiency of the FIG. 2 signcryption scheme used by the FIG. 2 system (this scheme being denoted by “IBSC” for Identifier-Based Signcryption), and the Boyen signcryption scheme described in the introduction (denoted “MIBS” for Multipurpose Identity-Based Signcryption). Only the computational effort is compared since bandwidth requirements are identical, and only the dominant operations are considered, namely multiplications in G₁ (abbreviated to “mls”), exponentiations in G₂ (abbreviated to “exps”), pairing computations (abbreviated to “cps”), inversions in Fₗ* (abbreviated to “invs”). The term F*ₗ is used to denote the multiplicative group of the field of l elements where |G₁|=l.

TABLE 1

| | | Sign/Encrypt | | | Decrypt/Verify | | |
|---|---|---|---|---|---|---|---|
| Scheme | | G₁ mls | G₂ exps | p cps | G₁ mls | p cps | F^{*}_{q} invs |
| MIBS | Number of | 3 | 1 | 1 | 2 | 4 | 1 |
| | Dominant | | | | | | |
| | Operations | | | | | | |
| | Timing | 121.7 ms | | | 184.4 ms | | |
| IBSC | Number of | 3 | 0 | 1 | 1 | 3 | 0 |
| | Dominant | | | | | | |
| | Operations | | | | | | |

| | | |
|---|---|---|
| Timing | 116.6 ms | 124.2 ms |

Both the number of dominant operations are listed and comparative timings for signing/encryption and decryption/verification. The timings were obtained for an instantiation of G₁, G₂ and p using the supersingular curve E: y²=x³+x defined over F_{q} where q is a 512-bit prime. This curve has q+1 points and the value of q was chosen such that q+1 has a 160-bit prime factor l. In this case the group GI is the subgroup of order l in E(F_{q}) and G₂ is the l-th roots of unity in F*_{q2}. The same computing platform was used for all operations, in this case a 667MHz G4 PowerPC running implementations written in C.

As can be seen from Table 1, the IBSC scheme is significantly more efficient, particularly during decryption/verification, than the prior-art MIBS scheme.

It will be appreciated that many variants are possible to the above described embodiments of the invention. For example, in the ENCRYPT algorithm used in FIG. 2, the computation:
f←H₃(W)⊕(J∥ID_{A}∥m)
   can be replaced by any symmetric-key encryption process Enc(w, J∥ID_{A}∥m) taking w as the encryption key for encrypting the string (J∥ID_{A}∥m); any deterministic processing carried out on w before it is used in the underlying encryption algorithm is taken to reside in Enc( ). In this case, in DECRYPT the corresponding computation:
f⊕H₃(w′)
   is replaced by the corresponding symmetric-key decryption operation Dec(w′, J′∥ID_{A}′∥m′) using w′ as the key.

In the embodiment described above with reference to FIG. 2, the ciphertext is anonymous in that the identity of the signer is not discernible except by party B; this is as a result of the identity ID_{A} of party A being concatenated with m and J for encryption. If anonymity is not required, then the identity ID_{A} of party A can be sent unencrypted as a separate element (any change to this identity before delivery to party B resulting in the verification step failing).

It will be appreciated that the order of concatenation of concatenated components does not matter provided this is known to both parties A and B. Indeed, these components can be combined in ways other than by concatenation. Thus, the concatenation carried out during signing and verification can be replaced by any deterministic combination function, whilst the concatenation carried out during encryption can be replaced by any combination function that is reversible (as the decryption process needs to reverse the combination done in the encryption process). It is also possible to include additional components into the set of components subject to combination.

It will be further appreciated that the message m can comprises any subject data including text, an image file, a sound file, an arbitrary string, etc.

In the foregoing description of embodiments of the invention it has been assumed that all the elements P, Q_{A} and Q_{B} (and their derivatives R, S_{A}, S_{B}) are members of G₁ and that the bilinear map p has the form:
p:G₁×G₁→G₂
   with both the Weil and Tate pairings being suitable implementations of the map. In fact, it is also possible for either one the elements Q_{A}, Q_{B} not to be restricted to G₁ provided it is in G₀ and further provided that the other of the elements is in G₁; in this case, the bilinear map can be of the form:
p:G₁×G₀→G₂
   with the Tate pairing being a suitable implementation. Where it is Q_{A} that is unrestricted to G₁, then the order of the elements in the pairings used for determining w and w′ in the foregoing embodiment described with respect to FIG. 2 should be reversed (the given order being suitable for Q_{B} being unrestricted to G₁), It will be appreciated that different versions of the hash function H¹( ) would need to be used for converting the identities ID_{A} and ID^{B} into Q_{A} and Q_{B,} one version generating an element in G₁ and the other generating an element in G₀ but not necessarily within G₁.

1. An identifier-based signcryption method in which a first party associated with a first element Q_{A} signcrypts subject data m intended for a second party associated with a second element Q_{B}, the first and second elements being formed from identifier strings ID_{A}, ID_{B} of the first and second parties respectively such that the first and second elements are both members of an algebraic group G₀ with at least one of these elements being in a subgroup G₁ of G₀ where G₁ is of prime order I and in respect of which there exists a computable bilinear map p; the method comprising the first party:
(a) signing m by computing:
X←rQ_{A}
where r is randomly chosen in Zₗ*;
h←H₂(C₁(at least X and m))
where H₂: {0,1}*→Zₗ and C₁( ) is a deterministic combination function,
J←(r+h)S_{A}
where S_{A}=sQ_{A} is a private key supplied by a trusted authority and s is a secret key held by the trusted authority;
(b) encrypting m and signature data by computing:
w as the bilinear mapping of elements rS_{A} and Q_{B}, and
f←Enc(w, C₂(at least J and m))
where Enc( ) is a symmetric-key encryption function using w as key, and C₂( ) is a reversible combination function;
(c) outputting ciphertext comprising X and f.

2. A method according to claim 1, wherein in step (b) the set of quantities to which the combination function C₂( ) is applied comprises at least J, m and the identity ID_{A} of the first party, whereby this identity is encrypted in the ciphertext.

3. A method according to claim 1, wherein in step (c) the identity ID_{A} of the first party is output in unencrypted form along with X and f.

4. A method according to claim 1, wherein the function C₁( ) is a concatenation function.

5. A method according to claim 1, wherein the function C₂( ) is a concatenation function.

6. A method according to claim 1, wherein the symmetric-key encryption function Enc( ) effects at least the followings operations:
forming a hash of the key w;
forming an exclusive-OR of the hash of w with the output of the combination function C₂( ).

7. A method according to claim 1, wherein both the first and second elements Q_{A}, Q_{B} are in the subgroup G₁ and the bilinear map p is of the form:
p:G₁×G₁→G₂
where G₂ is a subgroup of a multiplicative group of a finite field.

8. A method according to claim 7, wherein the bilinear map is a Weil or Tate pairing.

9. A method according to claim 1, wherein only one of the first and second elements Q_{A}, Q_{B} is restricted to the subgroup G₁ and the bilinear map p is of the form:
p:G₁×G₀→G₂
where G₂ is a subgroup of a multiplicative group of a finite field.

10. A method according to claim 9, wherein the bilinear map is a Tate pairing.

11. Apparatus adapted for carrying out the method of claim 1.

12. A computer-readable medium storing a computer program arranged to condition a program-controlled computer, when executed by the latter, to carry out the method of claim 1.

13. A method according to claim 1, wherein the second party on receiving ciphertext components X′, f′ purportedly from the first party as identified by identity ID_{A}′:
(d) decrypts the received ciphertext by computing:
w′ as a bilinear mapping of the elements X′ and S_{B}
where S_{B}=sQ_{B} is a private key supplied to the second party by the trusted authority, and the order position of S_{B} in the mapping is the same as for Q_{B} in the mapping effected during computation of w,
Dec(w′,f′)
where Dec( ) is a symmetric-key decryption function complimenting Enc( ), with the result being subject to a reverse of the combination function C₂( ) whereby to recover at least: J′ and m′ ;
(e) verifies that the message is from the first party by computing:
Q_{A}′←H₁(ID_{A}′)
where H₁( ) is a hash function;
h′←H₂(C₁(at least: X′ and m′))
and then checking whether:
p (P,J′)=p (R, X′+h′Q_{A}′)
where P is an element of G₁ and R=sP is a public key element formed by the trusted authority.

14. A system comprising data-sending apparatus adapted to carry out the method of claim 1, data-receiving apparatus adapted to carry out the operations including:
(d) decrypting the received ciphertext by computing:
w′ as a bilinear mapping of the elements X′ and S_{B},
where S_{B}=sQ_{B} is a private key supplied to the second party by the trusted authority, and the order position of S_{B} in the mapping is the same as for Q_{B} in the mapping effected during computation of w,
Dec(w′,f′)
where Dec( ) is a symmetric-key decryption function complimenting Enc( ),
with the result being subject to a reverse of the combination function C₂( ) whereby to recover at least: J′ and m′: and
(e) verifying that the message is from the first party by computing:
Q_{A}′←H₁(ID_{A}′)
where H₁( ) is a hash function,
h′←H₂(C₁(at least: X′ and m′))
and then checking whether:
p(P,J′)=p(R, X′+h′Q_{A}′)
where P is an element of G₁ and R=sP is a public key element formed by the trusted authority, and trusted authority apparatus for providing the global public key R and the private keys S_{A} and S_{B}.

15. An identifier-based signcryption method in which a second party associated with a second element Q_{B} decrypts and verifies received ciphertext <X′,f′> that is purportedly a signcryption of subject data m by a first party associated with a first element Q_{A}, the first and second elements being formed from identifier strings ID_{A}, ID_{B} of the first and second parties respectively such that the first and second elements are both members of an algebraic group G₀ with at least one of these elements being in a subgroup G₁ of G₀ where G₁ is of prime order l and in respect of which there exists a computable bilinear map p; the method comprising the second party:
(a) decrypting the received ciphertext by computing:
w′ as a bilinear mapping of elements X′ and S_{B}
where S_{B}=sQ_{B} is a private key supplied by a trusted authority, s is a secret key held by the trusted authority;
Dec(w′,f′)
where Dec( ) is a symmetric-key decryption function using w′ as key, with at least quantities J′ and m′ being recovered from the result;
(b) verifying that the message is from the first party by computing:
Q_{A}′←H₁(ID_{A}′)
where H₁( ) is a hash function;
h′←H₂(C₁(at least: X′ and m′))
where H₂:{0,1}*→Zₗ and C₁( ) is a deterministic combination function, and then checking whether:
p(P, J′)=p(R, X′+h′Q_{A}′)
where P is an element of G₁ and R=sP is a public key element formed by the trusted authority.

16. A method according to claim 15, wherein in step (a) the identity ID_{A}′ of the first party is also recovered from the result provided by the decryption function Dec( ).

17. A method according to claim 16, wherein the identity ID_{A}′ of the first party is received in unencrypted form along with X′ and f′.

18. A method according to claim 15, wherein the function C₁( ) is a concatenation function.

19. A method according to claim 15, wherein the symmetric-key encryption function Dec( ) effects at least the followings operations:
forming a hash of the key w′,
forming an exclusive-OR of the hash of w′ with f′.

20. A method according to claim 15, wherein both the first and second elements Q_{A}, Q_{B} are in the subgroup G₁ and the bilinear map p is of the form:
p:G₁×G₁→G₂
where G₂ is a subgroup of a multiplicative group of a finite field.

21. A method according to claim 20, wherein the bilinear map is a Weil or Tate pairing.

22. A method according to claim 15, wherein only one of the first and second elements Q_{A}, Q_{B} is restricted to being in the subgroup G1 and the bilinear map p is of the form:
p:G₁×G₀→G₂
where G₂ is a subgroup of a multiplicative group of a finite field.

23. A method according to claim 22, wherein the bilinear map is a Tate pairing.

24. Apparatus adapted to carry out the method of claim 15.

25. A computer-readable medium storing a computer program arranged to condition a program-controlled computer, when executed by the latter, to carry out the method of claim 15.
